(19) United States
(12) Patent Application Publication
(10) Pub. No.: US 2019/0329632 A1
(43) Pub. Date: Oct. 31, 2019

(54) GLASS PROTECTIVE COVERING

(71) Applicant: Todd Neufer, Rock Springs, WY (US)

(72) Inventor: Todd Neufer, Rock Springs, WY (US)

(21) Appl. No.: 15/967,566

(22) Filed: Apr. 30, 2018

(51) Int. Cl. B60J 1/20; B32B 7/06; B32B 7/12; B32B 17/06; B32B 38/00; B32B 37/12

(52) U.S. Cl. CPC B60J 1/2094; B32B 7/06; B32B 7/12; E06B 5/10; B32B 38/0004; B32B 37/12; B32B 2605/006; B32B 17/064

(57) ABSTRACT

A method of guarding glass against damage during breakage after the glass has been installed in an object, the glass having a outward surface, a n inward surface, and a peripheral edge surface therein around, comprising the step of removing a backing material from an impact resistant material; and adhering the impact resistant material on the outward surface of the glass.

### BACKGROUND OF THE INVENTION

### (1) Field of the Invention

The invention relates to means and methods for preventing and protecting glass, like automobile windshields, from damage caused by impacts from flying objects. In particular the invention relates to a barrier placed around the periphery of the glass to absorb the impact from objects and thereby prevent damage.

(2) Background of the Invention

Damage to glass, and by example, windshields caused by debris or other impacts have long been a problem. Many patents have issued and a substantial business thrives respecting the repair of such damage. For a long time it was believed that long cracks, that is cracks over six inches in length could not be repaired. However, shorter cracks referred to as stone damage were repairable. Later through significant developments in the field it became possible to repair long cracks.

Accordingly, various prior arts have disclosed such related inventions, whereby the following patents are herein incorporated by reference for their supportive teachings, in which are U.S. Pat. Nos. 5,116,441, 5,425,827, 5,429,692, and 6,485,082.

There is a thriving business in the replacement of cracked windshields that either cannot be repaired or which are believed to be unrepairable. In fact replacement is vastly more common than repair.

Despite these thriving businesses damage to windshields present costs to the consumer because of the cost of the repair or replacement. When insurance covers the damage then there is an insurance company loss that is passed on to consumers through their premiums. Also tons of unrecycled waste is created year after year.

Impacts that cause damage near the glass edge nearly always result in an edge crack that is a crack running through the impact point to the edge of the glass. These cracks are also nearly always long cracks that are over 6 inches in length. By contrast impacts in the middle area of the windshield quite often result only in the limited damage known as chips or stone damage, that is a bulls-eye, a star break or a combination and absent any long crack. Thus the problem of windshield damage in the peripheral area is considerably greater than in the middle. Long cracks, especially edge cracks, demand attention soon after cracking and most end up being replaced.

Windshields are installed with a rubber or plastic and in some cases metal, molding. Presently, most moldings are 1-2 centimeters wide, about 50% of the molding width extending over the glass. The maximum known molding width covers 2 cm of the windshield glass. In the past a windshield was prepared with a pre-installed molding prior to shipping called “encapsulated.” This molding was a conventional molding covering about 1 centimeter of glass and was not intended to prevent damage from impacts. They are hard to remove and install and are a being discontinued.

### SUMMARY

In view of the foregoing disadvantages inherent in the known types of apparatus to degrade pollution percent or like in the prior art, the present invention provides an improved apparatus.

A method of guarding glass against damage during breakage after the glass has been installed in an object, the glass having a outward surface, a n inward surface, and a peripheral edge surface therein around, comprising the step of: removing a backing material from an impact resistant material; and adhering the impact resistant material on the outward surface of the glass. Wherein the impact resistant material is also adhered to an inward surface that is opposite to the outward surface of the glass. Wherein the object having the sheet of glass is a vehicle. Wherein the object having the sheet of glass is a house window. Wherein the object having the sheet of glass is a cabinet. Wherein the object having the sheet of glass is a glass door. Wherein the resistant material increases the insulative value of the object thus inhibiting heat and cold transference through the glass.

Accordingly, it may be another embodiment of the present invention to provide a method of guarding a vehicle windshield against damage during handling and transportation and against impact damage after the windshield has been installed, having a front surface, a back surface, and a peripheral edge surface therein around, comprising the step of pealing a backing material from an impact resistant material; and adhering the impact resistant material on an outward surface of the windshield.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a front view of a windshield having the inventive film applied in an exemplary OEM application.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The invention is a method and means for protecting windshields from impacts that would cause damage, most importantly cracks of the kind that generally require replacement of the windshield, although in some cases repair is possible. In this invention, when applied to a windshield already installed, the new installed impact absorbing barrier/material is adhered to the peripheral areas of the windshield, the sides, top and bottom, adjacent to the molding and extending a selected width into the glass area. When applied before the windshield is installed, the barrier can extend to the edge of the windshield so that a portion of it is captured under the windshield molding. The barrier may be dear or opaque, and may be of a variety of materials such as plastic film, rubber or any other known material.

Plastic film is supplied and used in many thicknesses, configurations and plastic formulations. Selection of a film thickness and plastic formulation for use in this invention is such as to provide good impact absorption sufficient to prevent damage from impact that would allow a crack to form. In practice the selected material will prevent any damage, even a chip because as will be seen a chip in the vulnerable peripheral area commonly leads to an edge crack. In order to minimize distortion of visibility the film should be as thin as possible consistent with achieving the impact absorption goal. This is more important at the sides than at the top and bottom.

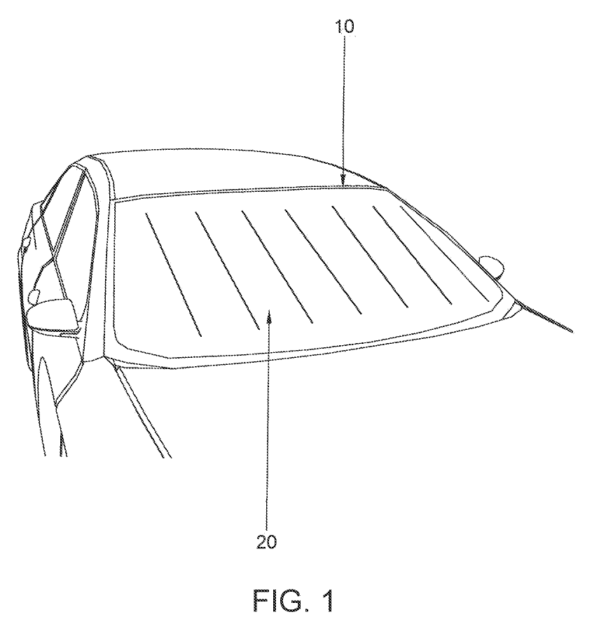

Referring to FIG. 1, in the present invention, an automobile windshield 10 having a molding around its periphery is the subject of the invention. A clear plastic film 20 is placed around the periphery inside the molding. The film 20 should have the selected dimension to fit to the entire windshield 10. It should be adhered permanently to the windshield by an adhesive layer. In many types of adherent material there is a backing layer (not shown) that needs to be removed before adhering to the windshield 10. Alternatively the film can be adhered in a manner that allows periodic replacement, for example if the film becomes damaged or worn or loses its clarity. Therefore, the film 20 will absorb impact and protect the windshield from rocks and other debris.

Over 90% of windshield long cracks are caused by impacts in the peripheral distance within 4 inches (approximately 10 cm) of the exposed periphery of the windshield, that is, within a margin measured from the molding to about 4 inches into the glass area. Stones cause most of these long cracks, although other flying debris can also cause such cracks.

The plastic film should be selected from a material that is clear and crack resistant and will not fog or discolor over time due to sunlight or severe weather conditions. An exemplary film is 3M Scotchcal™. This is an 8 mils urethane plastic film sold by 3M. It has adhesive on one side that will be activated by a solution of 25% isopropyl alcohol and 75% water, then this film can be applied to a surface for protection. The film could be thicker, for example up to about 30 mils. A film should be as thick as necessary to absorb impact but not so thick as to interfere with any function of the windshield or the wipers.

Another material that may be used for the absorbent material can be purchased from Kittrich™, on web site: http://www.rakuten.com/prod/kittrich-54-22003-15y-56-5-in-x-45-in-clear-super-vinyl/270400862.html?, with product description and name of: Kittrich™ 54-22003-15Y 56.5 in.×45 in., Clear Super Vinyl, as a clear vinyl covering, double polished clear vinyl.

A preferred method of providing the peripheral protection for OEM applications is to prepare a one-piece four-sided dear plastic frame of the selected dimensions. If there is a backing material, that backing material needs to be removed. It would be shaped to fit along the inside of the molding although it could extend up to or under the molding to the glass edge. Most windshields are curved at the sides, and some are curved at the top or bottom. Therefore, the four-sided plastic frame is configured to match the periphery of the windshield against the molding and extending inward into the viewing area the selected distance. The fame therefore should match the curves to give a uniform distance from the molding.

A preferred method of providing the protection for aftermarket applications uses a roll of selected workable film, typically purchased with a width from 3 inches to 8 inches, for example. Whereby, selected strips of material would be placed on the windshield from the top to the bottom of the windshield, where each one is placed next to the previous strips, as illustrated in FIG. 1. In most cases, the non-stick backing on the selected film will need to be removed to allow for adherence to the windshield. Thus, the strips of film are laid onto the windshield one next to the other. In one embodiment, the strips are first cut to be longer than the desired length. Thus, once the strip is adhered to the windshield, the excess length can then be marked for the exact place to cut the strips, and then the strip is cut to the exact configuration of the curvature and length of each windshield and to abut to the window periphery molding.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

For example, although the present disclosure discusses the use in the field of vehicle windshields, one skilled in the art of will easily understand that the described disclosure will also apply to all forms of glass protection. Specifically, one obvious example is in the use of covering windows of houses, glass doors, sliding glass door, cabinets with glass, even television screens may be covered. All of these examples will be improved from receiving the additional covering as described in this disclosure.

Additionally, although the present disclosure teaches of a single layer of protective material being placed on an outside of the windshield, or glass, one skilled in the art will easily understand that there are added benefits if the protective layer were to also be added on an inside surface of the glass. In this modification, in the situation where glass is being broken, glass shards will be prevented from falling on the ground or making contact with a person, thus preventing often-serious damage to a person. In particular, when the protected glass is layered on both sides with the protective material, those two layers will form a type of retaining device, that will retain the glass in a relative safe position, and from being liberated into the air, on the ground, or make dangerous contact with a person. It is noted that the adhesive side of the protective material, or merely static bonding if so used, will help maintain the glass in close proximity to the original position of the glass even when the glass is now in a broken form.

Finally, it is understood by those skilled in the art of glass, that by adding one or even two layers of the protective material there is the added benefit of increasing the insulation benefits, or R value as it is sometimes referred to in the insulative arts.

It is noted, with this windshield covering on the inside of the vehicle windshield, it will protect occupants from getting glass shards or pieces in their eyes, which could cause blindness in an accident or a collision with an animal or piece of falling debris from another motorist or an act of god like hail storms or any other destruction that has been known to break glass, like birds, or wind storms.

Although the invention has been explained in relation to its preferred embodiment, it is to be understood that many other possible modifications and variations can be made without departing from the spirit and scope of the invention.

I/We claim:

1. A method of adding a layer of impact resistant transparent material over a window having a outward surface, an inward surface, and a peripheral edge therearound, comprising the step of:
providing a roll of impact resistant transparent material having an adhesive layer on one side, a backing material covering the adhesive layer, and a longitudinal edge on either side thereof;
cutting a plurality of strips of the impact resistant transparent material to a length that has an excess length that is longer than the window length to be covered;
removing the backing material from the strips of the plurality of impact resistant transparent material;
placing and adhering the plurality of impact resistant transparent material strips on the outward surface of the window so that longitudinal edges abut to each other and completely cover the window in its entirety; and
cutting off the excess lengths at a position that will enable the impact resistant transparent material strips to end at the peripheral edge of the window.

2. The method of claim 1, wherein the impact resistant material is also placed on an inward surface that is opposite to the outward surface of the window.

3. The method of claim 2, wherein the window is a vehicle windshield.

4. The method of claim 2, wherein the window is a house window.

5. The method of claim 2, wherein the window is located in a cabinet.

6. The method of claim 2, wherein the window is a glass door.

7. The method of claim 2, wherein the impact resistant transparent material increases the insulative value of the window thus inhibiting heat and cold transference therethrough.
